(19) United States
(12) Patent Application Publication
(10) Pub. No.: US 2025/0388047 A1
(43) Pub. Date: Dec. 25, 2025

(54) MECANUM WHEEL

(71) Applicant: VANORA ROBOTS PRIVATE LIMITED, Mangaluru (IN)

(72) Inventor: Krishnan R Nambiar, Kanhangad (IN)

(73) Assignee: VANORA ROBOTS PRIVATE LIMITED, Mangaluru (IN)

(21) Appl. No.: 19/245,190

(22) Filed: Jun. 20, 2025

(30) Foreign Application Priority Data
Jun. 22, 2024 (IN) 202341088005

(51) Int. Cl. B60B 19/00; B60B 19/12

(52) U.S. Cl. CPC B60B 19/003; B60B 19/12; B60B 2310/204; B60B 2320/10; B60B 2360/10; B60B 2360/341; B60B 2380/12; B60B 2380/70; B60B 2900/131; B60B 2900/211; B60B 2900/212

(57) ABSTRACT

An improved mecanum wheel that can be configured as a left-hand or a right-hand mecanum wheel is provided. The improved mecanum wheel is designed to enhance maneuverability and precision in various applications, such as robotics and vehicles. This improved mecanum wheel features a unique configuration with an inner rim 102, an outer rim 104, one or more rollers 106, one or more sandwich bolts 108, one or more invertible roller guides 110, one or more perpendicular bolts 112, one or more roller caps 114, and one or more guide pockets. The integration of these elements ensures (i) the flexibility in configuring the improved mecanum wheel as a left-hand or a right-hand mecanum wheel and (ii) precise and controlled movement of the mecanum wheel, thereby improving the overall performance of machines or robots equipped with it.

### TECHNICAL FIELD OF THE INVENTION

The embodiments herein generally relate to mecanum wheels, particularly to an improved mecanum wheel that is configured as both a left-hand mecanum wheel and a right-hand mecanum wheel of a machine/vehicle with reduced manufacturing costs, and a simplified manufacturing process.

### BACKGROUND OF THE INVENTION

Mecanum wheel is an omnidirectional wheel design for a land-based vehicle offering movement in any direction. The mecanum wheel is widely used in robotics and vehicle applications due to its unique ability to provide omnidirectional mobility. The existing mecanum wheel typically consists of multiple rollers that are placed between an inner rim and an outer rim at an angle to the mecanum wheel's axis. These multiple rollers allow the existing mecanum wheel to achieve omnidirectional movement by providing a combination of forward and sideways motion when rotated. While the mecanum wheel is versatile and effective in various applications, it includes certain drawbacks and limitations. The mecanum wheel has a more complex design compared to standard wheels, which leads to increased manufacturing costs and requires more maintenance expertise. The presence of multiple rollers and guide systems for the movement of the multiple rollers adds complexity to the existing mecanum wheel. The existing mecanum wheel is less energy-efficient than the standard wheels, especially when moving heavy loads or in high-friction environments. Rolling motion of the multiple rollers creates increased internal resistance, demanding more power to achieve equivalent speed and movement. The multiple rollers on the mecanum wheel may generate noise and vibrations during operation, which may be undesirable in certain applications, such as quiet environments or precision robotics tasks.

In the mecanum wheel field, the terms “LH” refer to “Left-Hand” and “RH” refer to “Right-Hand” configurations, respectively. These designations are used to indicate the orientation of an individual mecanum wheel on a vehicle or robot. This mecanum wheel's orientation in the vehicle or robot provides omnidirectional movement capability, which allows the vehicle or robot to move in any direction without changing its orientation. However, this omnidirectional movement capability is highly dependent on the correct installation and orientation of the mecanum wheels in LH and RH.

The LH and RH mecanum wheels are manufactured separately for use, as the LH mecanum wheel and the RH mecanum wheel are not interchangeable, as the inner rim and the outer rim differ for both the LH mecanum wheel and the RH mecanum wheel. Manufacturing the inner rim and the outer rim of the LH and RH mecanum wheels separately may lead to increased manufacturing costs. The arrangement of the multiple rollers is specific to either the LH or RH mecanum wheel due to the separate configuration for the LH and RH mecanum wheels. The

LH and RH mecanum wheels are designed to create different movement patterns. Control software for vehicles or robots with mecanum wheels is typically calibrated for designated LH and RH wheel orientations. Swapping these mecanum wheels without updating the software may reflect a change in orientation and can also lead to control complications and unpredictable movement. The optimized roller arrangement in LH and RH mecanum wheels ensures stability and maneuverability in their intended configurations. Interchanging them may result in decreased stability and control, potentially obstructing the vehicle's or robot's navigation. In safety-critical applications like autonomous vehicles or industrial robots, using an incorrect LH or RH configuration mecanum wheel poses safety risks. Unpredictable movement patterns can lead to collisions or other accidents.

Roller damage in the mecanum wheels is a more common occurrence.

Currently, most users often find themselves in a position to purchase an entirely new wheel, whether LH or RH, and, in certain instances, a complete set including both the LH and RH wheels. Roller damage can manifest in various scenarios, including: (i) collisions with solid surfaces like walls, steps, or obstructions, particularly when the robot or vehicle slides sideways into these objects, (ii) the entry of dust and water into roller bearings, resulting in gradual damage that impacts the mecanum wheel's performance and lifespan, (iii) exceeding the weight-bearing capacity of the robot or the vehicle, which can exert excessive stress on the rollers, making them susceptible to damage, (iv) navigating rough outdoor surfaces where the mecanum wheels may encounter conditions that contribute to wear and tear of the rollers, and (v) natural degradation of the rollers due to regular usage, which can diminish the mecanum wheel's overall functionality. In addition to roller damage, it's worth noting that rim damage is also a possibility. Rim damage can occur under the following circumstances: (i) collisions with solid surfaces like walls or obstacles can result in rim damage, particularly when the mecanum wheel is misaligned or improperly positioned, and (ii) overloading the robot or the vehicle can also increase the risk of rim damage, as the mecanum wheel may be subjected to excessive strain.

Roller damage is a common issue that can arise from various factors, including impacts, debris ingress, overloading, and challenging terrains, and rim damage, though less frequent, can also occur under specific conditions. Thus, all forms of damage share a common outcome of requiring a new mecanum wheel, which has to be purchased as a complete set, including the LH and RH mecanum wheel configurations.

In an existing design of the mecanum wheel, rollers are connected between both the inner rims and outer rims with different angle provisions for the LH and RH configurations. Even though the inner rim and the outer rim functions are similar, the design of the existing mecanum wheels is different, which results in manufacturing the inner rim of LH and inner rim of RH mecanum wheels separately. Similarly, the outer rims for LH and RH are also required to be manufactured separately. It also leads to increased manufacturing costs due to the need for having four separate molding casts. Further, in the existing design of the mecanum wheels, the rollers are placed at an angle with roller joints in the inner rim and the outer rim of the mecanum wheels. Manufacturing the inner rim and the outer rim with the roller joints is difficult as the roller joints are at an angle and require more post-processing with special tools to obtain the angular holes on the inner rim and the outer rim. Similarly, the absence of identical outer rims for LH and RH configurations, despite their shared function, leads to elevated production expenses due to unique designs. The inability to easily replace individual damaged rollers significantly prolongs the repair process, causing increased downtime in the existing designs. The inability to convert an LH wheel into an RH wheel necessitates the maintenance of separate spare wheels for LH and RH configurations. The absence of roller fitting screws oriented perpendicular to the inner and outer rims leads to elevated manufacturing costs for the wheel and a higher error rate during the post-manufacturing drilling process. The absence of common outer and inner rims for each wheel results in an increased number of separate parts through separate molding casts, driving up manufacturing costs.

In view of the above, the existing mecanum wheels suffer from using different rims for both LH and RH with increased manufacturing costs. Hence there is a need for an economically feasible improved mecanum wheel that can be used as both an LH and RH mecanum wheel of the machine/vehicle with reduced manufacturing costs.

### OBJECT OF THE INVENTION

A principal object of the invention is to provide an improved mecanum wheel that can be configured as both a left-hand and a right-hand mecanum wheel to reduce manufacturing complexity and cost.

Another object of the invention relates to enhancing maneuverability and precision of the improved mecanum wheel in robotics and vehicle applications.

Another object of the invention is to introduce an adaptable roller guide mechanism for the improved mecanum wheel that allows seamless conversion between left-hand and right-hand configurations without requiring separate manufacturing processes.

Another object of the invention is to improve durability and maintenance efficiency of the improved mecanum wheel by enabling easier roller and rim replacements to reduce downtime and operational costs.

These and other objects and characteristics of the present invention will become apparent from the further disclosure to be made in the detailed description given below.

### SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present invention provides an improved mecanum wheel that can be configured as both a left-hand and a right-hand mecanum wheel, reducing manufacturing complexity and cost. The invention addresses the limitations of conventional mecanum wheels, which require separate manufacturing for LH and RH configurations, leading to increased production costs and maintenance challenges. This improved mecanum wheel integrates an innovative invertible roller guide mechanism that allows seamless reconfiguration between LH and RH orientations, ensuring precise and controlled movement while maintaining high stability and durability.

In some embodiments, this solution overcomes the drawbacks of traditional mecanum wheels by introducing a common inner and outer rim design, reducing the need for separate molding casts and minimizing post-processing requirements. The use of perpendicular harnessing and optimized roller alignment enhances mechanical efficiency, ensuring smooth omnidirectional movement with reduced friction and energy consumption. In some embodiments, the wheel structure is designed to simplify maintenance, enabling easy roller replacements and reducing downtime in robotics and vehicle applications.

Embodiments of the invention may also provide a method for manufacturing a cost-effective and adaptable mecanum wheel. This method involves utilizing invertible roller guides to configure the wheel for LH or RH use without requiring separate parts, leveraging precision-aligned roller pockets to maintain structural integrity and maneuverability. The wheel's ability to function across diverse environments, combined with its reduced manufacturing complexity and improved durability, enables its application in autonomous vehicles, industrial robotics, and mobility platforms requiring enhanced omnidirectional movement.

To the accomplishment of the foregoing and related ends, one or more aspects comprise the features hereinafter fully described and particularly pointed out in the claims. The following description and the drawings set forth in detail certain illustrative features of one or more aspects. These features are indicative, however, of a few of the various ways in which the principles of various aspects may be employed, and this description is intended to include all such aspects and their equivalents.

### BRIEF DESCRIPTION OF DRAWINGS

The embodiments herein will be better understood from the following detailed description with reference to the drawings, in which:

FIGS. 1A-1E illustrate different views of an improved mecanum wheel that is configured as both a left-hand mecanum wheel and a right-hand mecanum wheel of a machine/vehicle according to some embodiments herein.

FIGS. 1F and 1G illustrate schematic representations of a first side of the inner rim of the left-hand mecanum wheel and the right-hand mecanum wheel, respectively, according to some embodiments herein.

FIGS. 1H and 1I illustrate schematic representations of a first side of the outer rim of the left-hand mecanum wheel and the right-hand mecanum wheel, respectively, according to some embodiments herein.

FIG. 2 illustrates a front view and a perspective view of a roller 106 of FIG. 1A according to some embodiments herein.

FIGS. 3A and 3B illustrate an outer rim of the improved mecanum wheel of FIG. 1A according to some embodiments herein.

FIGS. 4A and 4B illustrate an inner rim of the improved mecanum wheel of FIG. 1A according to some embodiments herein.

FIG. 5 illustrates an invertible roller guide of the improved mecanum wheel of FIG. 1 according to some embodiments herein.

FIGS. 6A and 6B are flow diagrams that illustrate a method of manufacturing an improved mecanum wheel with precise roller orientation according to some embodiments herein.

FIGS. 7A-7D illustrates quantitative improvements of the improves mecanum wheel with respect to traditional mecanum wheels according to some embodiments herein.

### DETAILED DESCRIPTION OF THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

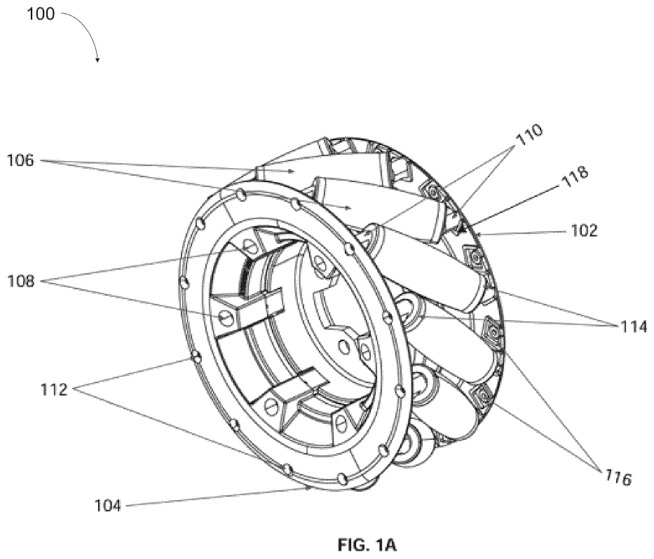

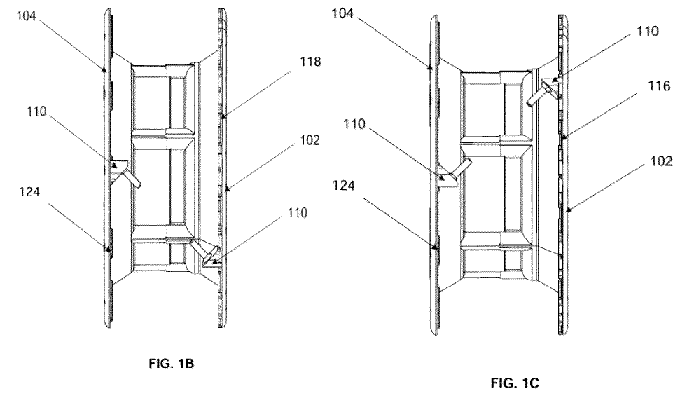

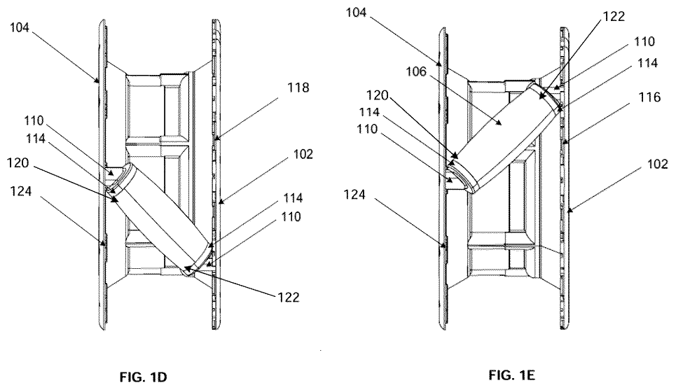

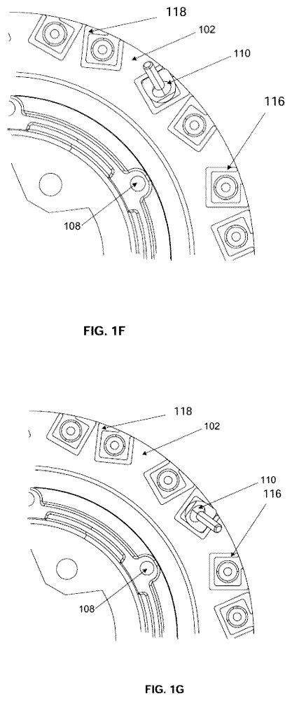

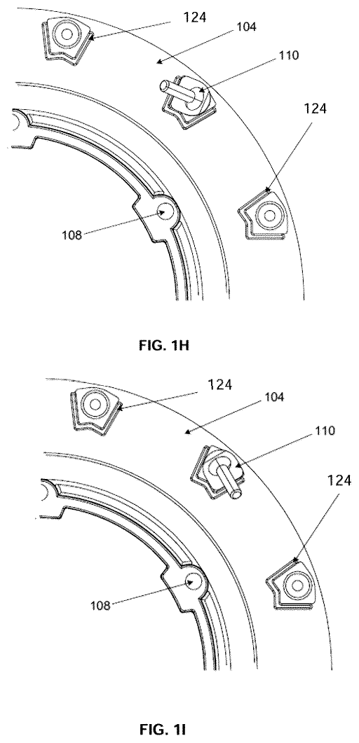

As mentioned, there remains a need for an improved mecanum wheel that is configured as both a left-hand (LH) mecanum wheel and a right-hand (RH) mecanum wheel of a machine/vehicle with reduced manufacturing costs. Referring now to the drawings, and more particularly to FIGS. 1A through 6B, where similar reference characters denote corresponding features consistently throughout the figures, preferred embodiments are shown.

FIGS. 1A-1E illustrate different views of an improved mecanum wheel that is configured as both a left-hand mecanum wheel and a right-hand mecanum wheel of a machine/vehicle according to some embodiments herein. The improved mecanum wheel includes an inner rim 102, an outer rim 104, one or more rollers 106, one or more sandwich bolts 108, one or more invertible roller guides 110, one or more perpendicular bolts 112, and one or more roller caps 114. The one or more invertible roller guides 110 are connected to a first end 120 and a second end 122 of the one or more rollers 106 through the one or more roller caps 114. The inner rim 102 provides an inner side of the mecanum wheel when mounted on the machine (e.g., a robot or a vehicle). The outer rim 104 provides an outer side of the mecanum wheel when mounted on the machine/robot.

The inner rim 102 includes a first side that comprises one or more pairs of first guide pockets. Each pair of first guide pockets comprises a left guide pocket 116 and a right guide pocket 118. The left guide pocket 116 and the right guide pocket 118 may be in the shape of a square cut. The outer rim 104 includes a first side comprising one or more second guide pockets 124. Each second guide pocket 124 may be in the shape of a W. The one or more invertible roller guides 110 maintain a pivot angle for the one or more rollers 106 and define an orientation for the one or more rollers 106 as shown in FIG. 1B for the left-hand mecanum wheel and in FIG. 1C for the right-hand mecanum wheel.

To configure the mecanum wheel as a left-hand mecanum wheel as shown in FIG. 1D, the one or more invertible roller guides 110, connected to the first end 120 of the one or more rollers 106, are configured to connect to each of the second guide pockets 124 at a first angle (e.g., 45-degree angle) positioned at the outer rim 104. Simultaneously, the one or more invertible roller guides 110, connected to the second end 122 of the one or more rollers 106, are configured to connect to the right guide pocket 118 located at the inner rim 102 at the first angle (e.g., 45-degree angle).

To configure the mecanum wheel as a right-hand mecanum wheel as shown in FIG. 1D from the left-hand mecanum wheel, the one or more invertible roller guides 110, connected to the first end 120 of the one or more rollers 106, are rotated to change from the first angle (e.g., 45-degree angle) to a second angle (e.g., 135-degree angle) at the outer rim 104. Simultaneously, the one or more invertible roller guides 110, connected to the second end 122 of the one or more rollers 106, are configured to connect to the left guide pocket 116 located at the inner rim 102 at the second angle (e.g., 135-degree angle)

In some embodiments, to configure the mecanum wheel as the left-hand mecanum wheel as shown in FIG. 1E from the right-hand mecanum wheel, the one or more invertible roller guides 110, connected to the first end 120 of the one or more rollers 106, are rotated to change from the second angle (e.g., 135-degree angle) to the first angle (e.g., 45-degree angle) at the outer rim 104. Simultaneously, the one or more invertible roller guides 110, connected to the second end 122 of the one or more rollers 106, are connected to the right guide pocket 118 located at the inner rim 102 at the first angle (e.g., 45-degree angle).

The one or more rollers 106 are inserted at the pivot angle of 45 degrees between the inner rim 102 and the outer rim 104. The one or more rollers 106 are harnessed perpendicularly to the inner rim 102 and the outer rim 104 and parallel to the mecanum wheel rotation axis, while maintaining the precise angle of the one or more rollers 106. In some embodiments, the one or more rollers 106 are harnessed with the help of the one or more invertible roller guides 110, which are attached to (i) the left guide pocket 116 or the right guide pocket 118 of the inner rim 102 and (ii) the second guide pocket 124 of the outer rim 104. The one or more invertible roller guides 110 replace the need for a long bolt running from the outer rim 104 to the inner rim 102, through the one or more rollers 106. The one or more rollers 106 are bulged at the center and form an integral part of the mecanum wheel when inserted between the inner rim 102 and the outer rim 104. The one or more sandwich bolts 108 hold the inner rim 102 and the outer rim 104 together for sandwiching the one or more rollers 106 between the inner rim 102 and the outer rim 104, thereby maintaining the precise pivot angle of 45 degrees for each roller 106. The one or more perpendicular bolts 112 hold the one or more invertible roller guides 110 in place in the mecanum wheel. The roller caps 114 protect ball bearings at both ends of each of the one or more rollers 106.

In some embodiments, the one or more rollers 106, connected to the left guide pocket 116 at the inner rim 102 and the second guide pocket 124 at the outer rim 104, define the orientation of the one or more rollers 106 to form a left front or a right rear mecanum wheel. In some embodiments, the one or more rollers 106, connected to the right guide pocket 118 at the inner rim 102 and the second guide pocket 124 at the outer rim 104, define the orientation of the one or more rollers 106 to form a right front or a left rear mecanum wheel of the machine. In some embodiments, the second guide pockets 124 at the outer rim 104 hold the one or more invertible roller guides 110 in place in the mecanum wheel, to maintain the orientation of the one or more rollers 106 when the mecanum wheel is in operation.

The mecanum wheel offers several distinct advantages over conventional mecanum wheel designs, which are as follows. For example, the pivot angle of 45 degrees for each roller 106, precisely maintained by the one or more sandwich bolts 108 and the one or more invertible roller guides 110, contributes to accurate omnidirectional maneuverability. This enables the machines or robots equipped with the present mecanum wheel to move in any direction with exceptional control and precision and makes it easier to navigate tight spaces and execute complex manoeuvres. The one or more rollers 106 are bulged at the center and form an integral part of the mecanum wheel, thereby enhancing stability during movement. The design minimizes wobbling or vibration and ensures a smoother and more stable ride for the machine or robot, especially when carrying sensitive or fragile payloads. The left guide pocket 116 and the right guide pocket 118 on the inner rim 102 and the second guide pockets 124 on the outer rim 104 provide flexibility in configuring the mecanum wheel for the left-hand side or right-hand side of the vehicle. This adaptability allows the user to choose between two distinct orientations: (i) a left front and a right rear configuration or (ii) a right front and a left rear configuration. Such flexibility proves particularly advantageous in various applications where specific movement patterns are required.

The one or more roller caps 114, employed to protect the ball bearings at both ends of each roller 106, contribute to the longevity of the mecanum wheel. By safeguarding these critical components from wear and debris, the mecanum wheel requires less frequent maintenance, thereby reducing downtime and maintenance costs. The precise pivot angle of 45 degrees for each roller 106, maintained by the one or more invertible roller guides 110 and the one or more perpendicular bolts 112, ensures that the machine or robot can execute movements with utmost precision. This level of control is very important in applications where accuracy and repeatability are crucial, such as industrial automation and robotics. The use of one or more sandwich bolts 108 to hold the inner rim 102 and the outer rim 104 together, in conjunction with the design features of the one or more rollers 106, ensures the mecanum wheel's durability and longevity. The present mecanum wheel can withstand the demands of various environments and applications without compromising its performance. The present mecanum wheel's design can be applied to a wide range of machines, including robots and vehicles. Its adaptability and precision render it suitable for deployment across diverse industries, ranging from manufacturing and logistics to entertainment and healthcare. The synergistic combination of these features and components in the mecanum wheel enhances the overall performance of machines or robots equipped with this technology. The result is a capacity for greater precision, stability, and agility, translating into heightened productivity and efficiency in various applications.

In some embodiments, the outer rim 104 of the mecanum wheel includes twelve second guide pockets 124 that hold the one or more invertible roller guides 110 in place. The inner rim 102 of the mecanum wheel includes twenty-four first guide pockets that define the orientation of the one or more rollers 106 for configuring the left-hand mecanum wheel and the right-hand mecanum wheel.

The presence of twenty-four first guide pockets on the inner rim 102 ensures a highly precise orientation for each of the mecanum wheel's rollers 106. This precision is crucial for maintaining consistent and reliable movement, especially in applications where precise control is essential. This reduces misalignment or deviation, resulting in more accurate and predictable machine or robot movements. The twenty-four first guide pockets on the inner rim 102 allow for multiple configurations of the mecanum wheel (i.e., the left-hand mecanum wheel and the right-hand mecanum wheel). Depending on how these first and second guide pockets 124 are utilized, the mecanum wheel can be adapted to create either (i) a left front and a right rear configuration or (ii) a right front and a left rear configuration. This flexibility in configuration provides versatility in various applications, enabling machines or robots to adapt to different operational requirements. The precise roller orientation, as achieved through the one or more first guide pockets and the second guide pockets 124, contributes to improved stability and control during operation. This precise roller orientation minimizes the chances of one or more rollers 106 slipping or veering off course, enhancing the machine or robot's overall performance. This precise roller orientation may lead to reduced maintenance requirements and a longer service life for the mecanum wheel, resulting in cost savings and decreased downtime.

The precise roller orientation achieved through the one or more guide pockets contributes to the mecanum wheel's improved overall performance.

Machines or robots equipped with this mecanum wheel can execute movements with greater accuracy and reliability, leading to enhanced productivity and efficiency in various applications. The one or more guide pockets simplify the assembly process by providing clear reference points for the one or more rollers 106 and the one or more invertible roller guides 110. This ease of assembly can save time and labor during the manufacturing or installation of the mecanum wheel.

In some embodiments, the mecanum wheel includes 12 rollers 106 that are inserted at an angle of 45 degrees between the inner rim 102 and the outer rim 104 to configure the mecanum wheel as a left-hand mecanum wheel. In some embodiments, the mecanum wheel includes 6 sandwich bolts 108 to hold the inner rim 102 and the outer rim 104 together.

In some embodiments, the mecanum wheel includes 24 perpendicular bolts 112 to hold the one or more invertible roller guides 110 in the mecanum wheel. In some embodiments, the mecanum wheel includes 24 roller caps 114 to protect ball bearings at both first end 120 and second end 122 of each of the one or more rollers 106. In some embodiments, the outer rim 104 of the mecanum wheel includes 12 second guide pockets that hold the one or more invertible roller guides 110 in place, and the inner rim 102 of the mecanum wheel includes 24 first guide pockets that define the orientation of the one or more rollers 106.

The one or more invertible roller guides 110 that are configured to rotate from the first angle to the second angle eliminate the need to manufacture separate left and right mecanum wheels. The one or more invertible roller guides 110 can rotate on a spot to change the orientation of the roller 106 to configure a left-hand or right-hand mecanum wheel. The one or more invertible roller guides 110 are designed in such a way that they achieve a perpendicular harnessing of the mecanum wheel. The mecanum wheel is easy to manufacture through an injection molding process due to the absence of undercuts found in the existing mecanum wheel design. Unlike the existing mecanum wheel, the present mecanum wheel eliminates the need for manual drilling of holes for the sandwich bolts 108 to hold the inner rim 102 and the outer rim 104 together.

This streamlined design translates into remarkable efficiency in production, exemplified by the ability to manufacture approximately 5000 mecanum wheels per day, without the need for special manufacturing tools. In comparison, the existing mecanum wheel necessitates a significantly longer timeframe of approximately 24 hours per mecanum wheel, requiring specialized machining tools for the manufacturing process. The accelerated manufacturing rate of the present mecanum wheel not only underscores its practical advantages but also contributes to enhanced productivity, reduced production timelines, and manufacturing costs by over 95% compared to conventional mecanum wheels. The design of the improved mecanum wheel enables the roller angle to be configured to form an LH or RH mecanum wheel as required.

FIGS. 1F and 1G illustrate schematic representations of a first side of the inner rim 102 of the left-hand mecanum wheel and the right-hand mecanum wheel, respectively, according to some embodiments herein. The first side of the inner rim 102 includes one or more pairs of first guide pockets. Each pair of first guide pockets comprises a left guide pocket 116 and a right guide pocket 118. The left guide pocket 116 and the right guide pocket 118 may be in the shape of a square cut. For configuring the left-hand mecanum wheel, the one or more invertible roller guides 110, connected to the second end 122 of the one or more rollers 106, are configured to connect to the right guide pocket 118 located at the inner rim 102 at a first angle (e.g., 45-degree angle). For configuring the right-hand mecanum wheel, the one or more invertible roller guides 110, connected to the second end 122 of the one or more rollers 106, are configured to connect to the left guide pocket 116 located at the inner rim 102 at a second angle (e.g., 135-degree angle).

FIGS. 1H and 1I illustrate schematic representations of a first side of the outer rim 104 of the left-hand mecanum wheel and the right-hand mecanum wheel, respectively, according to some embodiments herein. The first side of the outer rim 104 includes one or more second guide pockets 124. Each second guide pocket 124 may be in the shape of a W. For configuring the left-hand mecanum wheel, the one or more invertible roller guides 110, connected to the first end 120 of the one or more rollers 106, are configured to connect to each of the second guide pockets 124 at a first angle (e.g., 45-degree angle) positioned at the outer rim 104. For configuring the right-hand mecanum wheel, the one or more invertible roller guides 110, connected to the first end 120 of the one or more rollers 106, are rotated to change from the first angle (e.g., 45-degree angle) to a second angle (e.g., 135-degree angle) at the outer rim 104.

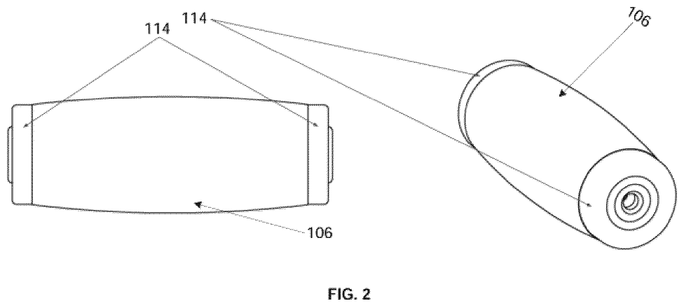

FIG. 2 illustrates a front view and a perspective view of the roller 106 of FIG. 1A according to some embodiments herein. The one or more rollers 106 include a first end 120 and a second end 122 that are connected to the one or more invertible roller guides 110 through the one or more roller caps 114. The one or more invertible roller guides 110 maintain a pivot angle for the one or more rollers 106 and define an orientation for the one or more rollers 106 as shown in FIG. 1B for the left-hand mecanum wheel and in FIG. 1C for the right-hand mecanum wheel. The functions, arrangement, and advantages of the roller 106 are as described above in FIGS. 1A-1I.

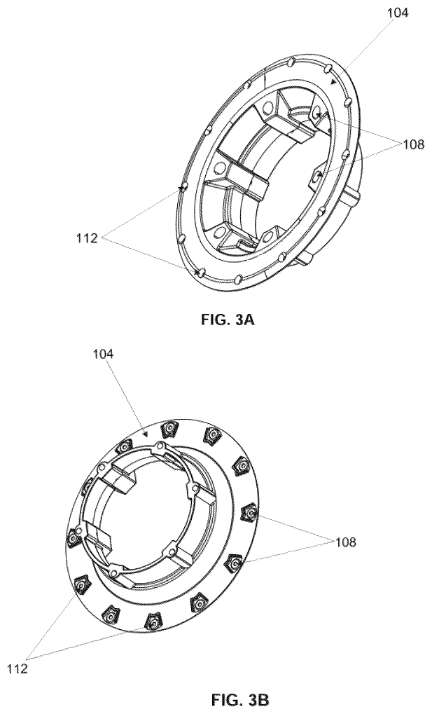

FIGS. 3A and 3B illustrate an outer rim 104 of the improved mecanum wheel of FIG. 1A according to some embodiments herein. FIG. 3A illustrates an outer side of the outer rim 104 of the improved mecanum wheel, and FIG. 3B illustrates an inner side/first side of the outer rim 104 of the improved mecanum wheel. The first side of the outer rim 104 comprises one or more second guide pockets 124. Each second guide pocket 124 may be in the shape of a W. The functions, arrangement, and advantages of the outer rim 104 are as described above in FIGS. 1A-1I.

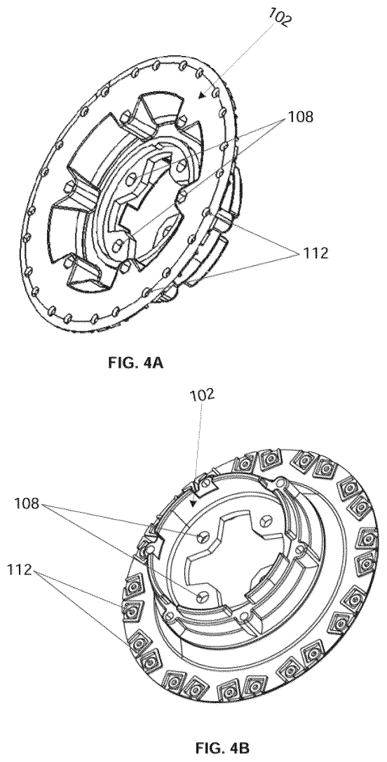

FIGS. 4A and 4B illustrate an inner rim 102 of the improved mecanum wheel of FIG. 1A according to some embodiments herein. FIG. 4A illustrates an outer side of the inner rim 102 of the improved mecanum wheel, and FIG. 4B illustrates an inner side/first side of the inner rim 102 of the improved mecanum wheel. The first side of the inner rim 102 includes one or more pairs of first guide pockets. Each pair of first guide pockets comprises a left guide pocket 116 and a right guide pocket 118. The left guide pocket 116 and the right guide pocket 118 may be in the shape of a square cut. The functions, arrangement, and advantages of the inner rim 102 are as described above in FIGS. 1A-1I.

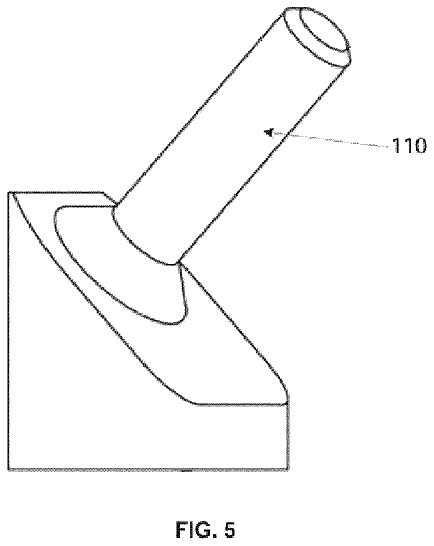

FIG. 5 illustrates an invertible roller guide 110 of the improved mecanum wheel of FIG. 1 according to some embodiments herein. The invertible roller guides 110 maintain a pivot angle for the one or more rollers 106 and define an orientation for the one or more rollers 106 as shown in FIG. 1B for the left-hand mecanum wheel and in FIG. 1C for the right-hand mecanum wheel. The functions, arrangement, and advantages of the invertible roller guides 110 are as described above in FIGS. 1A-1I.

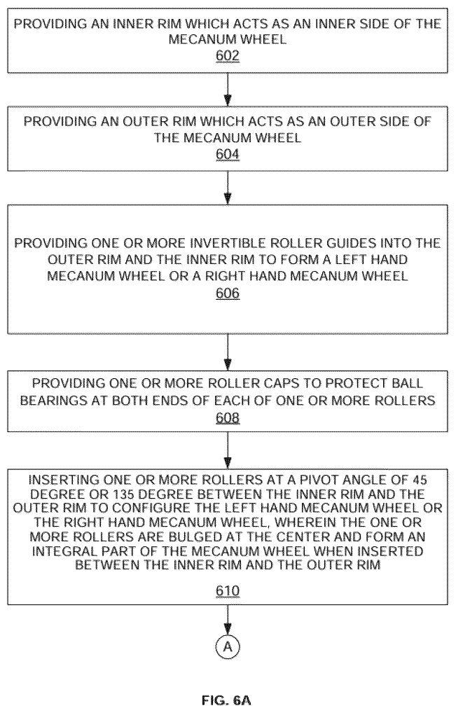

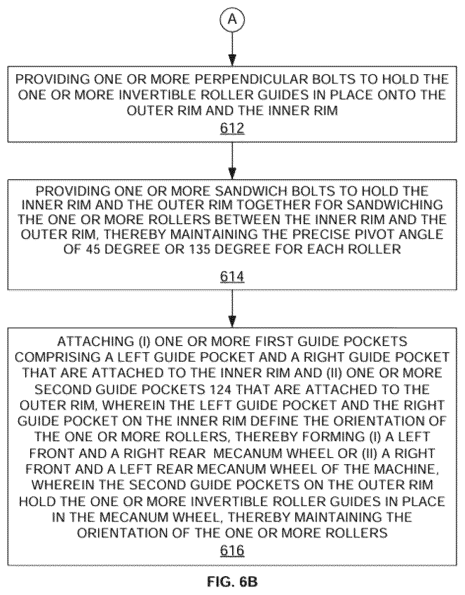

FIGS. 6A and 6B are flow diagrams that illustrate a method of manufacturing an improved mecanum wheel that can be configured as both a left-hand mecanum wheel and a right-hand mecanum wheel of a machine/vehicle according to some embodiments herein. At step 602, an inner rim 102 provides an inner side of the mecanum wheel. At step 604, an outer rim 104 provides an outer side of the mecanum wheel. At step 606, one or more invertible roller guides 110 are inserted into the outer rim 104 and the inner rim 102 to form a left-hand mecanum wheel or a right-hand mecanum wheel. The one or more invertible roller guides 110 include (i) one or more first guide pockets comprising a left guide pocket 116 and a right guide pocket 118 and (ii) one or more second guide pockets 124. The left guide pocket 116 and the right guide pocket 118 on the inner rim 102 define the orientation of the one or more rollers 106, and the second guide pockets 124 on the outer rim 104 maintain the orientation of the one or more rollers 106, thereby forming (i) a left front and a right rear mecanum wheel or (ii) a right front and a left rear mecanum wheel of the machine. At step 608, one or more roller caps 114 protect ball bearings at both ends of each of the one or more rollers 106.

At step 610, one or more rollers 106 are inserted at a pivot angle of 45 degrees or 135 degrees between the inner rim 102 and the outer rim 104 to configure the left-hand mecanum wheel and the right-hand mecanum wheel, respectively. The one or more rollers 106 are bulged at the center and form an integral part of the mecanum wheel when inserted between the inner rim 102 and the outer rim 104. At step 612, one or more perpendicular bolts 112 hold the one or more invertible roller guides 110 in place onto the outer rim and the inner rim. At step 614, one or more sandwich bolts 108 hold the inner rim 102 and the outer rim 104 together for sandwiching the one or more rollers 106 between the inner rim 102 and the outer rim 104, thereby maintaining the precise pivot angle of 45 degrees or 135 degrees for each roller 106.

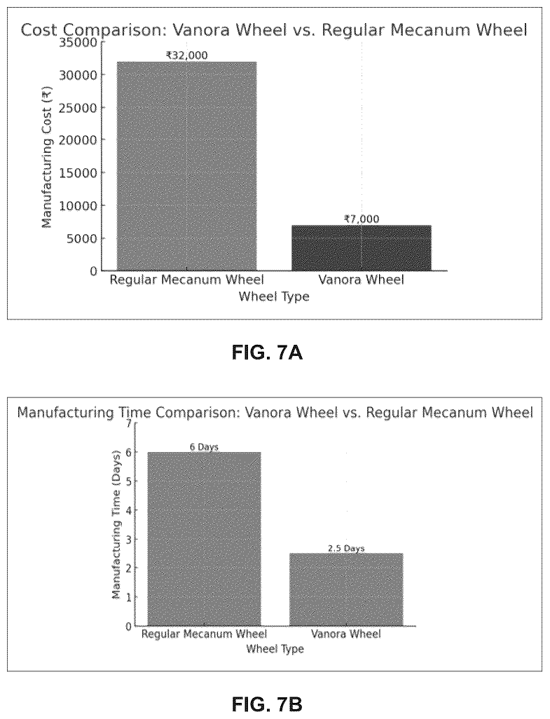

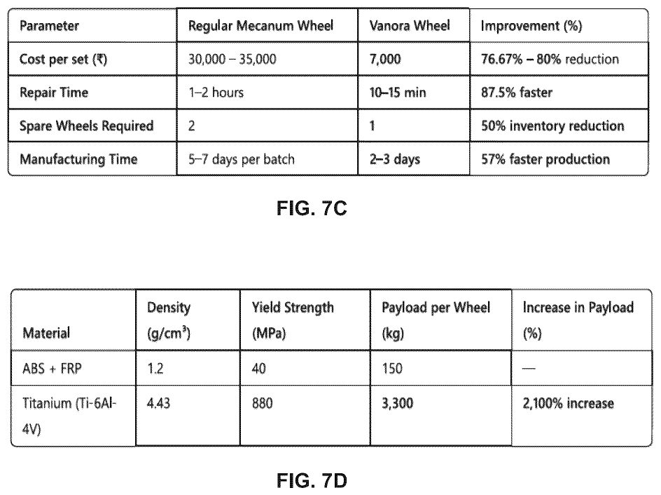

FIGS. 7A-7D illustrates quantitative improvements of the improve mecanum wheel with respect to traditional mecanum wheels according to some embodiments herein. FIG. 7A highlights the cost difference between the improved mecanum wheel and the regular mecanum wheel, showing a reduction in manufacturing cost from approximately [symbol] 32,000 to [symbol] 7,000, resulting in a cost reduction of up to 80%. FIG. 7B compares the manufacturing time of the improved mecanum wheel with that of a regular mecanum wheel, indicating a reduction from an average of 6 days to approximately 2.5 days, representing a 57% faster production rate. FIG. 7C illustrates significant improvement of the improve mecanum wheel with respect to traditional mecanum wheels by reducing manufacturing costs by 80%, repair time by 87.5%, spare part requirement by 50%, and production time by 57%. These improvements make the improve mecanum wheel a more practical and economical choice for robotics applications.

According to an example embodiment, FIG. 7D illustrates results of performed quantitative analysis of how changing material of the improved mecanum wheel affects payload capacity. Here, current material (ABS+FRP) is compared with strongest material (titanium). The table theoretically illustrates an increase in payload capacity per wheel from 150 kgs to 3300 kgs, a 2100% improvement in strength.

An improved mecanum wheel 100 that can be configured as either a left-hand mecanum wheel or a right-hand mecanum wheel, comprising: one or more rollers 106, wherein each of the one or more rollers 106 has a first end 120 and a second end 122; one or more invertible roller guides 110, wherein each of the one or more invertible roller guides 110 has a first end connected to the first end 120 of said roller 106 and a second end connected to the second end 122 of said roller 106; an inner rim 102, wherein the inner rim 102 includes one or more pairs of first guide pockets, wherein each pair of the one or more pairs of first guide pockets comprises a left guide pocket 116 and a right guide pocket 118, wherein said one or more pairs of first guide pockets define the orientation of the one or more rollers 106 for configuring the improved mecanum wheel 100 as either the left-hand mecanum wheel or the right-hand mecanum wheel; an outer rim 104, wherein the outer rim 104 includes one or more second guide pockets 124, wherein the one or more second guide pockets 124 maintain the orientation of the one or more rollers 106 during movement; one or more perpendicular bolts 112, wherein the one or more perpendicular bolts 112 secure the one or more invertible roller guides 110 to the inner rim 102 and the outer rim 104 to maintain the pivot angles of the one or more rollers 106, wherein the one or more invertible roller guides 110, when rotated, allow the one or more rollers 106 to be re-oriented, enabling the improved mecanum wheel 100 to be reconfigured as either the left-hand mecanum wheel or the right-hand mecanum wheel. Each of the one or more rollers 106 is positioned between the inner rim 102 and the outer rim 104 at a pivot angle of either a first angle 45 degrees or a second angle 135 degrees to facilitate omnidirectional movement. The improved mecanum wheel 100 further comprises one or more roller caps 114 positioned at both the first end 120 and the second end 122 of each of the one or more rollers 106. The improved mecanum wheel 100 further comprises one or more sandwich bolts 108, configured to securely fasten the inner rim 102 and the outer rim 104 together, sandwiching the one or more rollers 106 between them. The one or more invertible roller guides 110 are configured to rotate on a spot to selectively change the orientation of the one or more rollers 106 from the first angle to the second angle and vice versa, enabling the conversion of the improved mecanum wheel 100 between the left-hand mecanum wheel and the right-hand mecanum wheel without requiring disassembly. The one or more second guide pockets 124 on the outer rim 104 are configured in the shape of a W to facilitate secure engagement of the one or more invertible roller guides 110 for controlled omnidirectional movement. The one or more roller caps 114 are designed to enclose and protect ball bearings at the first end 120 and the second end 122 of each of the one or more rollers 106. The one or more perpendicular bolts 112 are oriented perpendicular to the inner rim 102 and outer rim 104, allowing for injection molding-based manufacturing. The improved mecanum wheel 100 is configured to support multiple mounting orientations, enabling a vehicle or a robotic system to adopt either a left front and right rear configuration or a right front and left rear configuration. The one or more rollers 106 are configured with a bulged center design to minimize vibrations and wobbling during movement of the vehicle or the robotic system.

The foregoing description of the specific embodiments will fully reveal the general nature of the embodiments herein so that others can, by applying current knowledge, readily modify and/or adapt these embodiments for various applications without departing from the generic concept. Such adaptations and modifications should be comprehended within the meaning and range of equivalents of the disclosed embodiments. It is to be understood that the phraseology or terminology employed herein is for the purpose of description and not limitation. Therefore, while the embodiments herein have been described in terms of preferred embodiments, those skilled in the art will recognize that the embodiments herein can be practiced with modifications within the scope of the appended claims.

We claim:

1. An improved mecanum wheel that can be configured as either a left-hand mecanum wheel or a right-hand mecanum wheel, comprising:
a) one or more rollers, wherein each of the one or more rollers has a first end, and a second end;
b) one or more invertible roller guides, wherein each of the one or more invertible roller guides has a first end connected to the first end of said roller, and a second end connected to the second end of said roller;
c) an inner rim, wherein the inner rim includes one or more pairs of first guide pockets, wherein each pair of the one or more pairs of first guide pockets comprising:
(i) a left guide pocket, and
(ii) a right guide pocket,
wherein said one or more pairs of first guide pockets define orientation of the one or more rollers for configuring the improved mecanum wheel as either the left-hand mecanum wheel or the right-hand mecanum wheel;
d) an outer rim, wherein the outer rim includes one or more second guide pockets, wherein the one or more second guide pockets maintain the orientation of the one or more rollers during movement; and
e) one or more perpendicular bolts, wherein the one or more perpendicular bolts secures the one or more invertible roller guides to the inner rim and the outer rim, to maintain pivot angles of the one or more rollers,
wherein the one or more invertible roller guides, when rotated, allow the one or more rollers to be re-oriented, to enable the improved mecanum wheel to be reconfigured as either the left-hand mecanum wheel or the right-hand mecanum wheel.

2. The improved mecanum wheel of claim 1, wherein each of the one or more rollers is positioned between the inner rim and the outer rim at a pivot angle of either a first angle (45 degrees) or a second angle (135 degrees) to facilitate omnidirectional movement.

3. The improved mecanum wheel of claim 1, wherein the improved mecanum wheel further comprises one or more roller caps positioned at both the first end and the second end of each of the one or more rollers.

4. The improved mecanum wheel of claim 1, wherein the improved mecanum wheel further comprises one or more sandwich bolts configured to securely fasten the inner rim and the outer rim together, sandwiching the one or more rollers between them.

5. The improved mecanum wheel of claim 1, wherein the one or more invertible roller guides are configured to rotate on a spot, to selectively change the orientation of the one or more rollers from the first angle to the second angle and vice versa, to enable conversion of the improved mecanum wheel between the left-hand mecanum wheel and the right-hand mecanum wheel without requiring disassembly.

6. The improved mecanum wheel of claim 1, wherein the one or more second guide pockets on the outer rim are configured in shape of a “W” to facilitate secure engagement of the one or more invertible roller guides for controlled omnidirectional movement.

7. The improved mecanum wheel of claim 1, wherein the one or more roller caps are designed to enclose and protect ball bearings at the first end and the second end of each of the one or more rollers.

8. The improved mecanum wheel of claim 1, wherein the one or more perpendicular bolts are oriented perpendicular to the inner rim and outer rim, allowing injection molding-based manufacturing.

9. The improved mecanum wheel of claim 1, wherein the improved mecanum wheel is configured to support multiple mounting orientations, enabling a vehicle or a robotic system to adopt either a left front and right rear configuration or a right front and left rear configuration.

10. The improved mecanum wheel of claim 1, wherein the one or more rollers are configured with a bulged center design to minimize vibrations and wobbling during movement of the vehicle or the robotic system.

11. The improved mecanum wheel of claim 1, wherein the inner rim and the outer rim are identically configured for use in both left-hand and right-hand orientations to eliminate need for separate molds.

12. The improved mecanum wheel of claim 1, wherein the one or more invertible roller guides are configured to rotate without detaching the inner rim and the outer rim for enabling in-field reconfiguration between the left-hand and right-hand orientations.

13. The improved mecanum wheel of claim 1, wherein each pair of the one or more pairs of first guide pockets on the inner rim is symmetrically arranged to define mirrored orientations of the one or more rollers for left-hand and right-hand conversion.

14. The improved mecanum wheel of claim 1, wherein the one or more roller caps are configured to enclose and shield ball bearings at the first end and the second end of each of the one or more rollers from particulate ingress and mechanical wear.

15. The improved mecanum wheel of claim 1, wherein the inner rim and the outer rim are free of undercuts to enable high-throughput injection molding without post-processing.

16. The improved mecanum wheel of claim 1, wherein the inner rim, outer rim, or the one or more rollers are constructed from fiber-reinforced polymers or metal alloys capable of supporting payloads exceeding 1000 kilograms per wheel.

17. The improved mecanum wheel of claim 1, wherein each of the one or more rollers comprises a bulged center region to enhance contact surface area, minimize operational vibration, and improve stability during omnidirectional movement.

18. A method of manufacturing an improved mecanum wheel that can be configured as both a left-hand mecanum wheel and a right-hand mecanum wheel, comprising:
a) providing an inner rim which acts as an inner side of the mecanum wheel;
b) providing an outer rim which acts as an outer side of the mecanum wheel;
c) providing one or more invertible roller guides into the outer rim and the inner rim to form a left hand mecanum wheel or a right hand mecanum wheel;
d) providing one or more roller caps to protect ball bearings at both ends of each of one or more rollers;
e) inserting one or more rollers at a pivot angle of 45 degree or 135 degree between the inner rim and the outer rim to configure the left hand mecanum wheel or the right hand mecanum wheel, wherein the one or more rollers are bulged at the center and form an integral part of the mecanum wheel when inserted between the inner rim and the outer rim;
f) providing one or more perpendicular bolts to hold the one or more invertible roller guides in place onto the outer rim and the inner rim;
g) providing one or more sandwich bolts to hold the inner rim and the outer rim together for sandwiching the one or more rollers between the inner rim and the outer rim, thereby maintaining the precise pivot angle of 45 degree or 135 degree for each roller; and
h) attaching (i) one or more first guide pockets comprising a left guide pocket and a right guide pocket that are attached to the inner rim and (ii) one or more second guide pockets that are attached to the outer rim, wherein the left guide pocket and the right guide pocket on the inner rim define the orientation of the one or more rollers, thereby forming (i) a left front and a right rear mecanum wheel or (ii) a right front and a left rear mecanum wheel of the machine, wherein the second guide pockets on the outer rim hold the one or more invertible roller guides in place, in the mecanum wheel, thereby maintaining the orientation of the one or more rollers.

19. The method of claim 18, wherein the one or more roller caps are positioned at both the first end and the second end of each of the one or more rollers to shield ball bearings from particulate ingress and reduce wear during rotational movement.

20. The method of claim 18, wherein the one or more invertible roller guides are configured to rotate from the first angle (45 degrees) to the second angle (135degrees), enabling in-field reconfiguration between the left-hand and right-hand orientations without requiring disassembly of the mecanum wheel.
